(19) United States
(12) Patent Application Publication
(10) Pub. No.: US 2015/0048536 A1
(43) Pub. Date: Feb. 19, 2015

(54) METHOD FOR COLOURING PRODUCTS ON A MOULD SURFACE

(71) Applicant: TAMICARE LIMITED, Heywood (GB)

(72) Inventor: Ehud Giloh, Heywood (GB)

(21) Appl. No.: 14/459,765

(22) Filed: Aug. 14, 2014

Related U.S. Application Data
(60) Provisional application No. 61/866,128, filed on Aug. 15, 2013.

(51) Int. Cl. B29C 37/00; B29C 67/00

(52) U.S. Cl. CPC B29C 37/0032; B29C 67/0007; B29C 2037/0035; B29K 2995/002; B29K 2105/25
USPC 264/78

(57) ABSTRACT

A method for providing a design on a moulded product during the product manufacturing process is disclosed. The method includes applying pigments onto at least a portion of a surface of a mould in a pre-determined design, and forming or curing a product on the surface of the mould so that pigments transfer onto the surface or into the polymeric product during forming or curing. The transfer of the pigments results in the creation of the colouring design on the product.

### CROSS REFERENCE TO RELATED APPLICATIONS

This application is a non-provisional of U.S. Ser. No. 61/866,128 filed on Aug. 15, 2013, the contents of which are fully incorporated by reference herein.

### FIELD OF THE INVENTION

This invention relates to a method to create colouring and stamp-printing of graphical figures and other decorations on polymeric products.

### BACKGROUND

Printing and painting, automatically or manually, on top of finished products in order to provide graphic figures, decorations, ornaments, texts, colouring of a specific area of the products, etc., are well-known in the art. Example methods are ‘tampon printing’, ‘silk (screen) printing’, decal transfer, inkjet printing, laser printing, airbrushing and hand painting.

However, there are cases where there are practical, physical or chemical limitations or challenges in providing permanent dying or fixing of the colour decoration to a substrate, such as textile or non-woven fabrics and the like during the manufacturing process. It is also simpler and more practical to print on a mould which is usually a solid substance rather than printing on a flexible material or fabric which are more difficult to handle. It is therefore desired to provide an alternative, sufficient link between the dye and the substrate in order to produce high quality printing and aesthetics.

### SUMMARY

The current invention discloses a method for providing a design such as colours, graphics, figures, decorations, ornaments, texts, or colouring of specific areas of a product, such as textile based products or non-woven based products, non-woven fabrics of any kind, moulded products and the like, just before or during the fabric, roll of fabric or the product manufacturing process.

In one embodiment, a method for providing a design on a moulded product during the product manufacturing process is disclosed. The method comprises applying pigments onto at least a portion of a surface of a mould in a pre-determined design, and forming or curing a product on the surface of the mould so that pigments transfer onto the surface of the polymeric product during setting or curing. The transfer of the pigments results in the creation of the design on the product surface or within at least part of its body.

In another aspect, the method comprises removing the formed product from the mould.

In another aspect, the pigments are applied with an applicator, the applicator comprising at least one of a silk printer, a tampon printer, a stamper, hand painting, a brush, a sprayer, or a sticker.

In another aspect, the design comprises at least one of graphic figures, decorations, ornaments, text, colours, or colour patterns.

In another aspect, the pigment comprises at least one of latex or polymer-based inks, paints, or solutions including dyes, colouring, and pigments.

In another aspect, the pigment is non-toxic.

In another aspect, the product comprises at least one of a garment, undergarment, bandage, bra, shoe, compression sleeve or sanitary product.

In another aspect, the mould surface comprises at least one of metal, glass, plastic, wood, ceramics, paper, leather, or a combination thereof.

In another aspect, the applicator 3D shape conforms to the mould shape at the designated printing area.

### DETAILED DESCRIPTION

In contrary to the usual process of making a product comprising a polymer, inside a mould or on top of a mould, and thereafter printing on or painting the product, the current invention comprises the steps of applying pigments onto at least a portion of a surface of a mould in a pre-determined design, and thereafter forming or curing a product on the surface of the mould so that pigments transfer onto the surface of the polymeric product during curing, setting, or moulding, the transfer of the pigments resulting in the creation of the design on the set, moulded or cured product. The design may include one or more of graphic figures, decorations, ornaments, text, colours, or colour patterns. The printing or the colouring of the formed product is enabled because the pigments or the dye materials that are attached to, or printed on the mould surface, are being transferred to the product body or to the product surface during the product forming or creation process, resulting in printed, coloured, decorated or tinted product.

In one example, a numeric number—25889, may be applied to a mould by using an ordinary, numeric ‘rubber stamp’ (such as in use in offices) to stamp a serial number on a mould. Once a product is fabricated on top of the printed number 25889 which was just stamped on the mould surface, the pigments will migrate to the polymeric material which is applied on the mould and the resulted product will be ‘marked’ or printed with the number 25889.

The printing or application process may be executed by any printing technique known in the art, particularly any method to attach pigments to a receptive surface of a mould. For example, tampon printing, tampoprinting, tampography, silk printing, screen printing, decal transfer, inkjet printing, laser printing, brushing, airbrushing, spraying, marking by hand and hand painting, hand writing, or by attaching pigments and dyes using an adhesive or sticker, or by any other suitable method that may be used to create transferrable visual designs, colours, printing or patterns on a surface of a mould.

Example of suitable pigments or dye materials include, but are not limited to, latex or polymer-based inks, paints, or solutions including dyes, colouring, and pigments, which are preferably non-toxic. Representative examples of a suitable pigment or dye printing material, e.g. Colanyl®, Flexonyl® and Hostafine® produced by Clariant.

In operation, the pigment or dye can be sprayed on the mould with or without the use of a stencil. Alternatively, a pigment or dye material is loaded into an applicator such as a printer or stamp. The applicator may have any shape and may conform to the 3D shape of the designated mould printing area. The applicator then applies the pigment of dye material to a surface of a mould. Any suitable amount of pigment or dye may be applied, depending in part on the surface area of the final product that is being covered. The pigment or dye material can be applied to the receptive surface of a mould in any configuration to form or create a pattern or design such as a geometric shape or group of letters. A product, such as a product made of polymeric material, is then formed on the top of the mould or inside the mould. During the moulding process, the pattern or design created by the pigment or dye transfers to the surface of the product, creating a design on the finished product. The pigments may penetrate deeper to the polymeric material creating a deeper stamp or colouring effect well within the finished product body (within the ‘wall thickness’ of the finished product.)

The term “mould” in the current invention is used to describe any former, mould, tool, wall or surface including, flat mould, 3D curved mould, conveyor belt, mesh or perforated surface, embossed or engraved surface or any combination of the above. Example suitable mould surfaces which can be used with the present application include, but are not limited to, metal, glass, plastic, wood, ceramics, paper, leather, or a combination of any of the above.

Representative polymeric materials for preparing the product include without limitation natural and synthetic rubbers such as latex emulsions. In one embodiment the product is produced as described in U.S. Pat. No. 7,767,133, U.S. Pat. No. 7,901,740, and U.S. Pat. No. 8,323,764, which are incorporated by reference in their entirety.

1. A method for providing a design on a moulded product during the product manufacturing process, the method comprises the steps of:
applying pigments onto at least a portion of a surface of a mould in a pre-determined design; and
forming or curing a product on the surface of the mould so that pigments transfer onto the surface of the polymeric product during setting or curing, wherein the transfer of the pigments results in the creation of the design on the product surface or within at least part of its body.

2. The method of claim 1, further comprising removing the formed product from the mould.

3. The method of claim 1 wherein the pigments are applied with an applicator, the applicator comprising at least one of a silk printer, a tampon printer, a stamper, hand painting, a brush, a sprayer, or a sticker.

4. The method of claim 1 wherein the design comprises at least one of graphic figures, decorations, ornaments, text, colours, or colour patterns.

5. The method of claim 1 wherein the pigment comprises at least one of latex or polymer-based inks, paints, or solutions including dyes, colouring, and pigments.

6. The method of claim 5 wherein the pigment is non-toxic.

7. The method of claim 1 wherein the product comprises at least one of a garment, undergarment, bandage, bra, shoe, compression sleeve or sanitary product.

8. The method of claim 1 wherein the mould surface comprises at least one of metal, glass, plastic, wood, ceramics, paper, leather, or a combination thereof.

9. The method of claim 1 wherein the applicator 3D shape conforms to the mould shape at the designated printing area.
